(19) United States
(12) Patent Application Publication
(10) Pub. No.: US 2017/0329040 A1
(43) Pub. Date: Nov. 16, 2017

(54) DOWNHOLE LOGGING SYSTEM WITH SOLID STATE PHOTOMULTIPLIER

(71) Applicant: GE Energy Oilfield Technology, Inc., Broussard, LA (US)

(72) Inventors: Helene Claire Climent, Sugar Land, TX (US); Stanislav Soloviev, Ballston Lake, NY (US); Sergei Ivanovich Dolinsky, Clifton Park, NY (US)

(73) Assignee: GE Energy Oilfield Technology, Inc., Broussard, LA (US)

(21) Appl. No.: 15/154,436

(22) Filed: May 13, 2016

(51) Int. Cl. G01V 5/08; E21B 49/08; E21B 49/00; G01T 1/20; G01T 1/24

(52) U.S. Cl. CPC G01V 5/08; E21B 49/08; E21B 49/00; G01T 1/248; G01T 1/2018

(57) ABSTRACT

A detector assembly for use in detecting radiation includes a scintillator and a solid state photomultiplier coupled to the scintillator. The detector assembly may include a light guide connected between the scintillator and the solid state photomultiplier. The detector assembly may be used within a receiver in a logging instrument for use downhole. The receiver is configured to detect radiation produced by an emitter or from naturally occurring sources.

### FIELD OF THE INVENTION

This application relates generally to downhole logging systems and more particularly, but not by way of limitation, to downhole logging systems with improved radiation detectors.

### BACKGROUND

Downhole logging systems have been used for many years to evaluate the characteristics of the wellbore, including the liquid-gas fraction of fluids in the wellbore and the lithology of the surrounding geologic formations. Induced gamma ray radiation has been used in many prior art logging systems. Such downhole monitoring tools are provided with a gamma ray emitter that includes a low-energy radioisotope (e.g., Americium-241) and a gamma ray detector. The extent to which the emitted gamma rays are attenuated or back scattered before reaching the detector provides an indication of the bulk density of the wellbore fluid and formations surrounding the monitoring tool.

Prior art gamma ray detectors include a scintillator and vacuum photomultiplier tube. The scintillator emits light in response to gamma ray radiation. The vacuum photomultiplier tube (PMT) converts the light emitted from the scintillator into an electric signal that is representative of the incident gamma ray radiation.

Although widely accepted, vacuum photomultiplier tubes are often susceptible to damage or performance degradation when exposed to mechanical shock, vibration and elevated temperatures. In downhole applications, sensor components must be made to withstand inhospitable conditions that include elevated temperatures, vibration and mechanical shock. Despite significant efforts to improve the durability of photomultiplier tubes, the fragility of photomultiplier tubes continues to present a common point of failure for downhole logging systems. There is, therefore a continued need for a downhole logging system that overcomes these deficiencies in the current state of the art. It is to this and other needs that the preferred embodiments are directed.

### SUMMARY OF THE INVENTION

In one aspect, the present invention includes a detector assembly for use in detecting radiation. The detector assembly includes a scintillator and a solid state photomultiplier coupled to the scintillator. The detector assembly may include a light guide connected between the scintillator and the solid state photomultiplier.

In another aspect, the present invention includes a multichannel receiver for use in detecting radiation. The receiver includes a plurality of detector assemblies and each of the plurality of detector assemblies includes a scintillator and a solid state photomultiplier coupled to the scintillator.

In another aspect, the present invention includes a logging instrument for use in a wellbore within a geologic formation. The logging instrument includes a receiver configured to detect radiation in the geologic formation. The receiver includes a processing module and a detector assembly. The detector assembly includes a plurality of scintillators and a plurality of photon detectors. Each of the plurality of photon detectors is paired with a corresponding one of each of the plurality of scintillators, and each of the plurality of photon detectors includes a plurality of photodiodes.

### BRIEF DESCRIPTION OF THE DRAWINGS

FIG. 1 is an elevational view of a downhole logging instrument constructed in accordance with an embodiment of the invention.

FIG. 2 is a cross-sectional depiction of the detector assembly of the downhole logging instrument of FIG. 1.

FIG. 3 is a cross-sectional depiction of the detector assembly and processor module of the downhole logging instrument of FIG. 1.

FIG. 4 is a cross-sectional depiction of a multichannel detector assembly.

FIG. 5 is a process flow diagram of signal processors used in connection with the multichannel detector assembly of FIG. 4.

### DETAILED DESCRIPTION OF THE PREFERRED EMBODIMENT

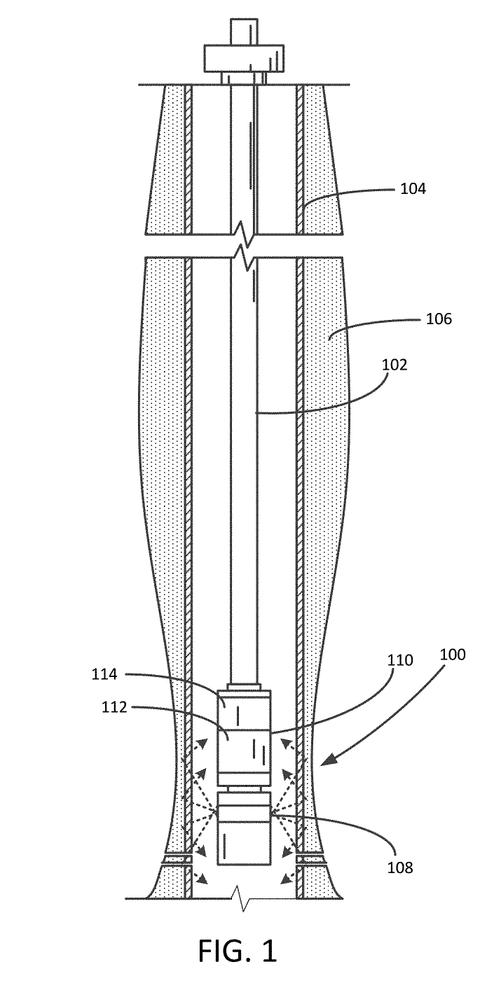

In accordance with a present embodiment of the invention, FIG. 1 shows an elevational view of a downhole logging instrument 100 attached to the surface through a cable 102 or series of pipes. The downhole instrument 100 and cable 102 or connecting pipes are disposed in a wellbore 104, which is drilled for the production of a fluid such as water or petroleum from a geologic formation 106. As used herein, the term “petroleum” refers broadly to all mineral hydrocarbons, such as crude oil, gas and combinations of oil and gas.

The logging instrument 100 may also include sensors, analyzers, control systems, power systems, data processors and communication systems, all of which are well-known in the art. It will be appreciated that the downhole instrument 100 may alternatively be configured as part of a larger downhole assembly. For example, in an alternate preferred embodiment, the downhole instrument 100 is attached to a submersible pumping system or as part of a measurement while drilling system. If the downhole instrument 100 is incorporated within a measurement while drilling system, the instrument 100 may be powered by one or more batteries rather than through an umbilical extending to surface-based power supplies. Although demonstrated in a vertical wellbore 104, it will be appreciated that downhole instrument 100 may also be implemented in horizontal and non-vertical wellbores. The preferred embodiments may also find utility in surface pumping applications and in other applications in which a sensor or other sensitive component is exposed to the potential of shock and vibration.

The logging instrument 100 includes a receiver 110 configured to detect radiation. The receiver 110 can be configured to detect gamma ray radiation, neutron radiation or both forms of radiation. The receiver 110 includes a detector assembly 112 and a processing module 114. The logging instrument may include an emitter 108 configured to produce gamma ray or neutron radiation at known energies. Alternatively, the logging instrument 100 relies on the emission of naturally-occurring radiation from formation 106 surrounding the wellbore 104. In either embodiment, the radiation released from the emitter 108 or formation 106 travels through the wellbore 104 to the receiver 110 through attenuation, reflection or back scatter, where it is measured and converted into measurement signals. The measurement signals can be interpreted to provide information regarding the characteristics of the wellbore 104, the fluid inside the wellbore 104 and the lithology of the surrounding formation 106. Although the detector assembly 112 is disclosed in connection with use in a downhole logging instrument 100, it will be appreciated that the detector assembly 112 may also find utility in other, unrelated applications and environments.

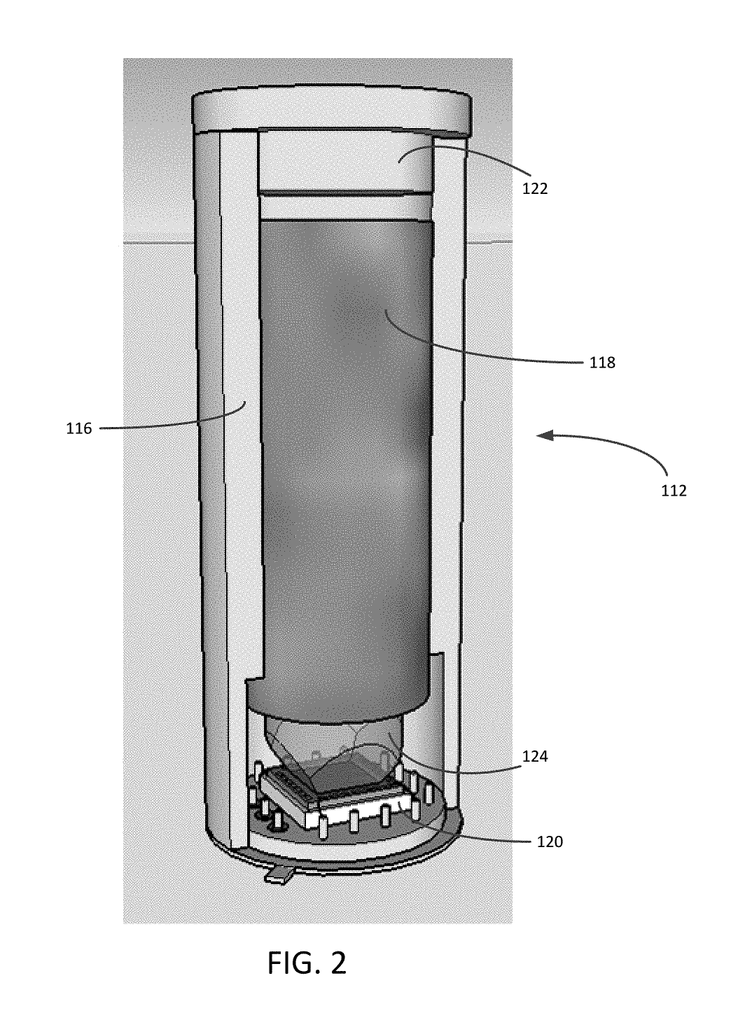

Turning to FIG. 2, shown therein is a cross-sectional view of the receiver detector assembly 112 of the receiver 110. The detector assembly includes a housing 116, a scintillator 118 and a photomultiplier or photon detector 120. In response to incident gamma ray or neutron radiation, the scintillator 118 emits light in accordance with well-known principles. In some embodiments, the scintillator 118 is manufactured from praseodymium-doped lutetium aluminum garnet (LuAG:Pr) or cerium-activated lanthanum chloride (LaCL3:Ce). In these embodiments, the scintillator 118 is configured to emit light in response to incident radiation at a design wavelength that matches the design wavelength of the photon detector 120. In some embodiments, the scintillator 118 is configured to emit light within the ultraviolet wavelength range and the photon detector 120 is configured to detect light within the ultraviolet range. The scintillator 118 can be retained within the housing 116 with a suspension 122 that isolates the scintillator 118 from mechanical shock and vibration.

The photon detector 120 is optically coupled directly or indirectly to the scintillator 118. In the embodiment depicted in FIG. 2, the scintillator 118 is coupled to the photomultiplier 116 with a light guide 124. In some embodiments, the light guide 124 is constructed from a substantially transparent silicone elastomer. Suitable silicone elastomers are commercially available from Dow Corning under the Sylgard® brand. In other embodiments, the scintillator 118 is secured directly to the photomultiplier with an adhesive or oil and the light guide 124 is omitted from the detector assembly 112.

Unlike the vacuum tube-based photomultipliers found in prior art downhole logging systems, the photon detector 120 is a solid state photomultiplier (SSPM). In some embodiments, the photon detector 120 includes an array of wide band gap avalanche photodiodes. In exemplary embodiments, the photon detector 120 includes an array of silicon carbide (SiC) avalanche photodiodes. In other embodiments, the photon detector 120 is made from gallium nitride (GaN) or gallium arsenide (GaAs). The solid state photon detector 120 presents a very small footprint, is mechanically robust and can operate at temperatures above 200° C. for extended periods. Additionally, the solid state photon detector 120 requires a much lower input voltage than prior art vacuum tube photomultiplier tubes.

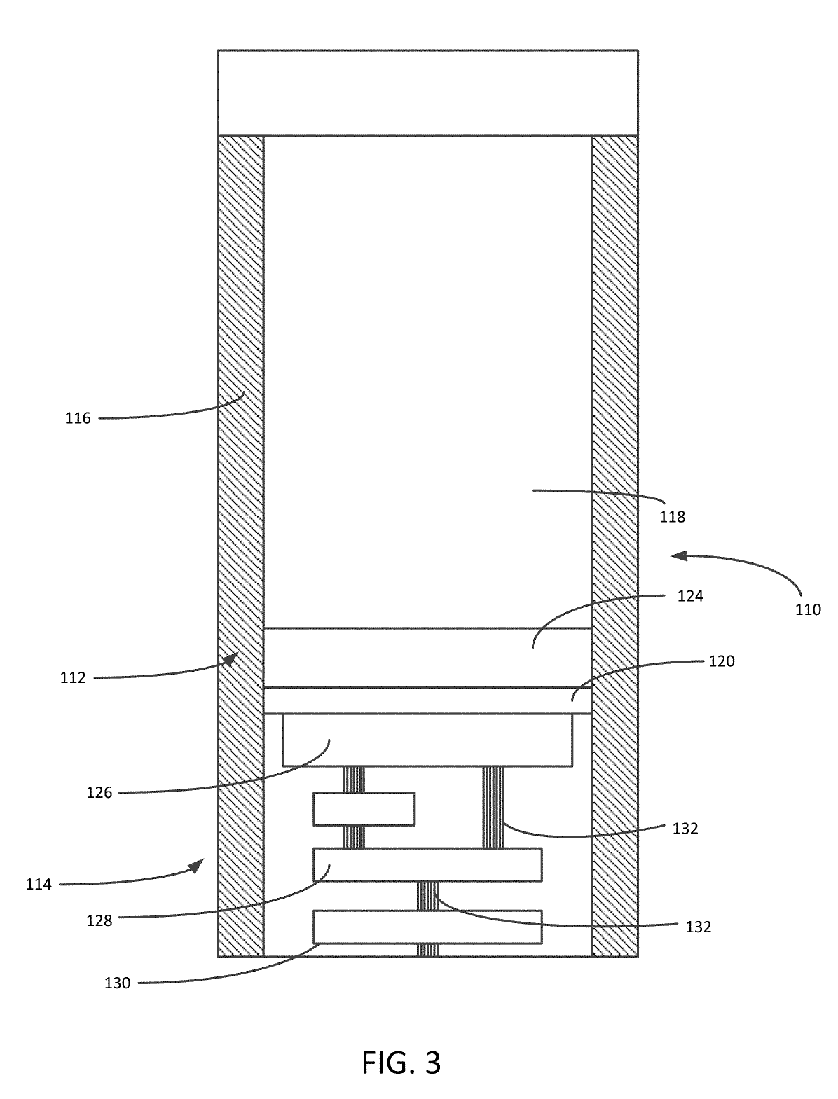

Turning to FIG. 3, the processing module 114 of the receiver 110 optionally includes a power module 126, a processor 128, a telemetry module 130 and series of data and power cables 132. The processor 128 controls the power module 126, which provides electrical power to the photon detector 120. The processor 128 also receives measurement signals from the photon detector 120. The telemetry module 130 is configured to exchange data and power from the receiver 110 through the deployment cable 102. It will be appreciated that some or all of the processing and control functionality within the receiver 110 can be remotely located in other components with the logging instrument 100 or in surface-based facilities.

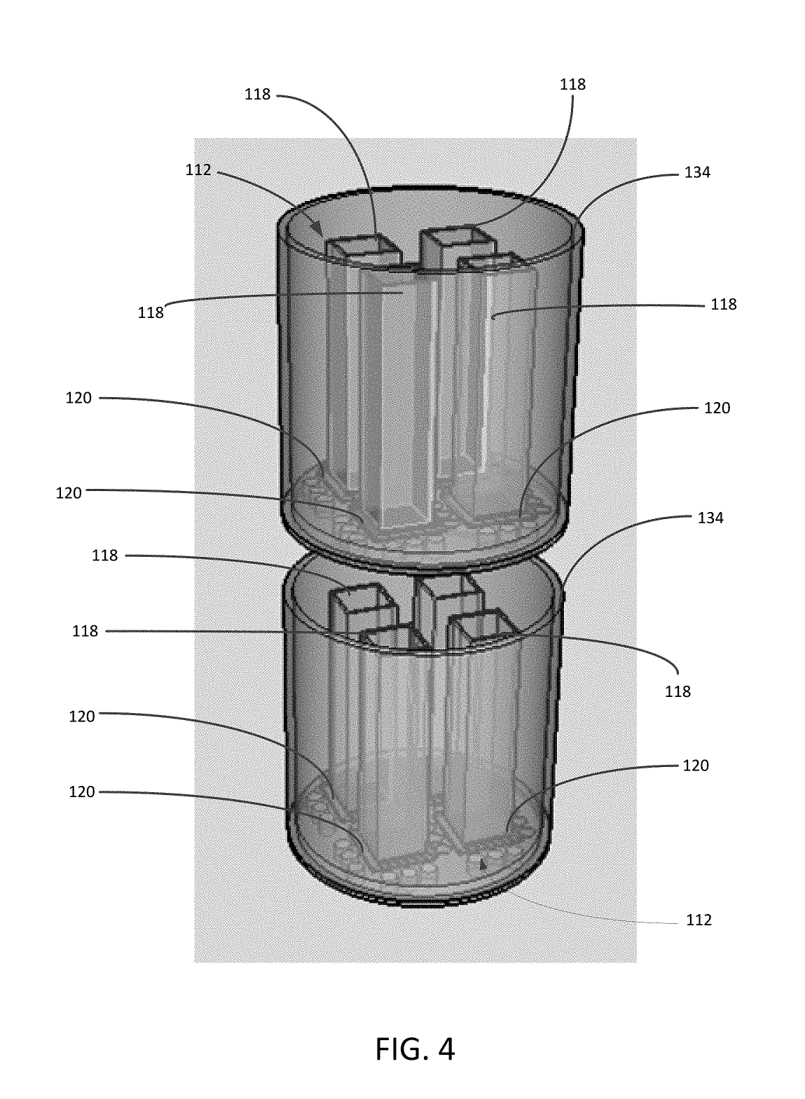

Turning to FIG. 4, shown therein is a multichannel embodiment of the receiver 110 that includes a plurality of detector assemblies 112. In the embodiment depicted in FIG. 4, the receiver 110 includes a plurality of detector assembly modules 134 that each includes a plurality of detector assemblies 112. Each of the detector assemblies 112 includes a scintillator 118 optically coupled to a corresponding photon detector 120. Each of the detector assemblies 112 may include a light guide 124, as depicted in FIG. 3.

The use of multiple detector assemblies 112 spaced around the receiver 110 permits the receiver 110 to provide an enhanced azimuthal measurement resolution. Rather than rotating a single photon detector and extrapolating recorded measurements to evaluate radiation across an azimuthal sweep, the multiple detector assemblies 112 of the embodiment in FIG. 4 permits the direct and simultaneous measurement of radiation from multiple regions surrounding the receiver 110. In these embodiments, the receiver 110 may exhibit a measurement resolution of about ¼ inch of vertical resolution and a 72+ sectoring capability. This presents a significant advantage in resolution over standard radiation detectors based on photomultiplier tubes that exhibit about 6 inches of vertical resolution and only about 32 sectors for horizontal sectoring. Thus, the receiver 110 depicted in FIG. 4 presents significant advantages in resolution and reliability over prior art detectors that rely on a single photomultiplier tube.

In some embodiments, receiver 110 includes a first set of detector assemblies 112 in which the scintillators 118 and photomultipliers 120 are designed to measure a first form of radiation and a second set of detector assemblies 112 in which the scintillators 118 and photomultipliers 120 are designed to measure a second form of radiation. Additionally, the orientation of the detector assemblies 112 within the receiver 110 makes possible the location of the source of the radiation measured by the receiver. For example, by discretely evaluating the radiation measured by each of the detector assemblies 112, the receiver 110 is capable of evaluating the location of the radiation source with azimuthal and vertical resolution based on the differences in the magnitude of radiation measured by the individual detector assemblies 112 within the receiver 110.

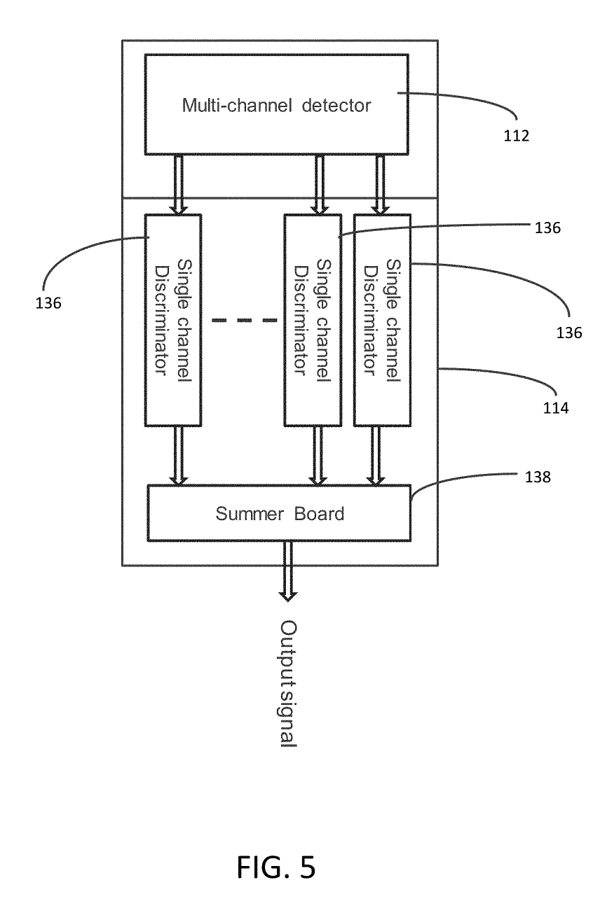

As shown in FIG. 5, in other embodiments the processing module 114 that is used in connection with the multichannel receiver 110 can include a plurality of single channel discriminator modules 136 and a summer board 138 that collects, aggregates and conditions the various signals produced by the individual detector assemblies 112. It will be appreciated that the single channel discriminator modules 136 may be incorporated in combination with the summer board into a single module or circuit.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A detector assembly for use in detecting radiation, the detector assembly comprising:
a plurality of scintillators; and
a plurality of solid state photon detectors, wherein each of the plurality of photon detectors is paired with a corresponding one of each of the plurality of scintillators.

2. The detector assembly of claim 1, further comprising a plurality of light guides, wherein each of the plurality of light guides is positioned between a corresponding pair of scintillators and photon detectors.

3. The detector assembly of claim 2, wherein each light guide is optically transparent and is chemically inert to the scintillator crystal.

4. The detector assembly of claim 1, wherein each of the plurality of photon detectors comprises a plurality of photodiodes.

5. The detector assembly of claim 1, wherein one or more of the plurality of scintillators comprises a scintillator crystal that emits light in the UV region.

6. The detector assembly of claim 5, wherein one or more of the plurality of solid state photon detectors is an avalanche photodiode that receive photons in UV region.

7. The detector assembly of claim 1, wherein the plurality of scintillators comprises:
a first set of scintillators, wherein each of the first set of scintillators is configured to emit light in response to a first form of radiation; and
a second set of scintillators, wherein each of the second set of scintillators is configured to emit light in response to a second form of radiation.

8. The detector assembly of claim 7, wherein the detector assembly includes one or more light guides, wherein each of the one or more light guides is positioned between a corresponding one of the plurality of scintillators and a corresponding photon detector.

9. The detector assembly of claim 8, wherein each of the one or more light guides is optically transparent and is chemically inert to the scintillator crystal.

10. The detector assembly of claim 1, further comprising:
a first set of scintillators, wherein each of the first set of scintillators is configured to emit light in response to radiation incident to the scintillator from a first direction; and
a second set of scintillators, wherein each of the first set of scintillators is configured to emit light in response to radiation incident to the scintillator from a second direction.

11. The detector assembly of claim 10, further comprising a plurality of light guides, wherein each of the plurality of light guides is positioned between a corresponding pair of scintillators and photon detectors.

12. A detector assembly for use in detecting radiation, the detector assembly comprising:
a plurality of scintillators;
a plurality of photon detectors, wherein each of the plurality of photon detectors is paired with a corresponding one of each of the plurality of scintillators, and wherein each of the plurality of photon detectors comprises a plurality of photodiodes; and
a plurality of light guides, wherein each of the plurality of light guides is positioned between a corresponding pair of scintillators and photon detectors.

13. The detector assembly of claim 12, wherein the plurality of scintillators comprises:
a first set of scintillators, wherein each of the first set of scintillators is configured to emit light in response to a first form of radiation; and
a second set of scintillators, wherein each of the second set of scintillators is configured to emit light in response to a second form of radiation.

14. The detector assembly of claim 13, wherein the plurality of scintillators comprises:
a first set of scintillators, wherein each of the first set of scintillators is configured to emit light in response to radiation incident to the scintillator from a first direction; and
a second set of scintillators, wherein each of the first set of scintillators is configured to emit light in response to radiation incident to the scintillator from a second direction.

15. The detector assembly of claim 14, wherein each of the first set of scintillators is configured to emit light in response to a first form of radiation and wherein each of the second set of scintillators is configured to emit light in response to a second form of radiation.

16. The detector assembly of claim 15, wherein the first form of radiation is gamma ray radiation and the second form of radiation is neutron radiation.

17. The detector assembly of claim 12, wherein the each of the plurality of scintillators comprises a scintillator crystal produced from a material selected from the group consisting of praseodymium-doped lutetium aluminum garnet (LuAG:Pr) and cerium-activated lanthanum chloride (LaCL3:Ce).

18. The detector assembly of claim 12, wherein each of the solid state photomultipliers is an avalanche photodiodes manufactured from a material selected from the group consisting of silicon carbide (SiC), gallium nitride (GaN) and gallium arsenide (GaAs).

19. A logging instrument for use in a wellbore within a geologic formation, the logging instrument comprising:
a receiver configured to detect radiation in the geologic formation, wherein the receiver comprises:
a processing module; and
a detector assembly, wherein the detector assembly comprises:
a plurality of scintillators; and
a plurality of photon detectors, wherein each of the plurality of photon detectors is paired with a corresponding one of each of the plurality of scintillators, and wherein each of the plurality of photon detectors comprises a plurality of photodiodes.

20. The logging instrument of claim 19, further comprising an emitter configured to produce a source of radiation.
